(19) United States
(12) Patent Application Publication
(10) Pub. No.: US 2017/0068374 A1
(43) Pub. Date: Mar. 9, 2017

(54) CHANGING AN INTERACTION LAYER ON A GRAPHICAL USER INTERFACE

(71) Applicant: Microsoft Technology Licensing, LLC, Redmond, WA (US)

(72) Inventors: Martin Jansky, Espoo (FI); Apaar Tuli, Helsinki (FI); Erkko Anttila, Espoo (FI); Timo-Pekka Viljamaa, Helsinki (FI)

(21) Appl. No.: 14/848,739

(22) Filed: Sep. 9, 2015

(51) Int. Cl. G06F 3/041

(52) U.S. Cl. CPC G06F 3/0416; G06F 3/0414

(57) ABSTRACT

An apparatus comprises at least one processing unit, at least one memory, a pressure level sensitive user input device and a graphical user interface. The at least one memory stores program instructions that, when executed by the at least one processing unit, cause the apparatus to detect that a pressure level applied on the pressure level sensitive user input device exceeds a predetermined pressure level, map the pressure level to an interaction layer of a set of interaction layers provided by the graphical user interface, detect release of the pressure on the pressure level sensitive user input device, and switch to the interaction layer mapped to the pressure level in response to detecting the release of the pressure level on the pressure level sensitive user input device.

### BACKGROUND

A user is able to control actions and elements of an application or applications on a graphical user interface using a touch sensitive input device. The touch sensitive input device may refer, for example, to a touch pad used in laptop computers to a touch sensitive display. When a selection of an item or element on the graphical user interface need to be made from a plurality of alternatives, an easy and intuitive way of selection is desirable.

### SUMMARY

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

In one embodiment, an apparatus is provided. The apparatus comprises at least one processing unit, at least one memory, a pressure level sensitive user input device and a graphical user interface. The at least one memory stores program instructions that, when executed by the at least one processing unit, cause the apparatus to detect that a pressure level applied on the pressure level sensitive user input device exceeds a predetermined pressure level, map the pressure level to an interaction layer of a set of interaction layers provided by the graphical user interface, detect release of the pressure on the pressure level sensitive user input device, and switch to the interaction layer mapped to the pressure level in response to detecting the release of the pressure level on the pressure level sensitive user input device.

In another embodiment, a method is provided. The method comprises detecting that a pressure level applied on the pressure level sensitive user input device exceeds a predetermined pressure level, mapping the pressure level to an interaction layer of a set of interaction layers provided by the graphical user interface, detecting release of the pressure on the pressure level sensitive user input device, and switching to the interaction layer mapped to the pressure level in response to detecting the release of the pressure level on the pressure level sensitive user input device.

In one embodiment, an apparatus is provided. The apparatus comprises at least one processing unit, at least one memory, a pressure level sensitive user input device and a graphical user interface. The at least one memory stores program instructions that, when executed by the at least one processing unit, cause the apparatus to detect that a pressure level applied on the pressure level sensitive user input device exceeds a predetermined pressure level, map the pressure level to an interaction layer of a set of interaction layers provided by the graphical user interface, provide an indication to a user, the indication indicating the interface interaction layer mapped to the pressure level, wherein the indication comprises at least one of a visual indication, a tactile indication and a vocal indication, detect release of the pressure on the pressure level sensitive user input device, and switch to the interaction layer mapped to the pressure level in response to detecting the release of the pressure level on the pressure level sensitive user input device.

Many of the attendant features will be more readily appreciated as they become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a system diagram depicting an apparatus including a variety of optional hardware and software components.

FIG. 2A illustrates an apparatus for selecting an interaction layer on a graphical user interface of the apparatus.

FIG. 2B illustrates an apparatus for selecting an interaction layer on a graphical user interface of the apparatus.

FIG. 3A illustrates a view on a graphical user interface of an apparatus.

FIG. 3B illustrates a view on a graphical user interface of an apparatus.

FIG. 4A illustrates a view on a graphical user interface of an apparatus.

FIG. 4B illustrates a view on a graphical user interface of an apparatus.

FIG. 5 illustrates a simplified application window view provided by an apparatus.

FIG. 6A illustrates a simplified application window selection view provided by an apparatus.

FIG. 6B illustrates a simplified application window selection view provided by an apparatus.

FIG. 7A illustrates an embodiment of pressure levels sensed by a pressure level sensitive user input device of an apparatus.

FIG. 7B illustrates an embodiment of pressure levels sensed by a pressure level sensitive user input device of an apparatus.

FIG. 8 illustrates a flow diagram illustrating an embodiment of a method for selecting an interaction layer

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples. Furthermore, as used in this application and in the claims, the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items.

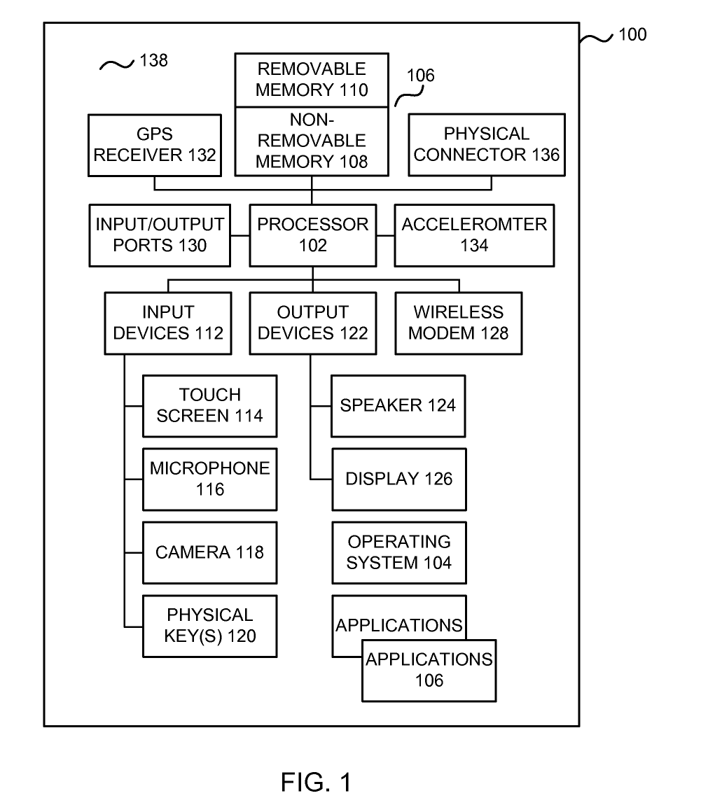

FIG. 1 is a system diagram depicting an apparatus 100 including a variety of optional hardware and software components, shown generally at 138. Any components 138 in the apparatus can communicate with any other component, although not all connections are shown, for ease of illustration. The apparatus can be any of a variety of computing devices (for example, a cell phone, a smartphone, a handheld computer, a tablet computer, a Personal Digital Assistant (PDA), etc.) and can allow wireless two-way communications with one or more communications networks, such as a cellular or satellite network.

The illustrated apparatus 100 can include a controller or processor 102 (e.g., signal processor, microprocessor, ASIC, or other control and processing logic circuitry) for performing such tasks as signal coding, data processing, input/output processing, power control, and/or other functions. An operating system 104 can control the allocation and usage of the components 138 and support for one or more application programs 106. The application programs can include common computing applications (e.g., email applications, calendars, contact managers, web browsers, messaging applications), or any other computing application.

The illustrated apparatus 100 can include a memory 106. The memory 106 can include non-removable memory 108 and/or removable memory 110. The non-removable memory 108 can include RAM, ROM, flash memory, a hard disk, or other well-known memory storage technologies. The removable memory 110 can include flash memory or a Subscriber Identity Module (SIM) card, which is well known in GSM communication systems, or other well-known memory storage technologies, such as “smart cards.” The memory 106 can be used for storing data and/or code for running the operating system 104 and the applications 106. Example data can include web pages, text, images, sound files, video data, or other data sets to be sent to and/or received from one or more network servers or other devices via one or more wired or wireless networks. The memory 106 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The apparatus 100 can support one or more input devices 112, such as a touchscreen 114, microphone 116, camera 118 and/or physical keys or a keyboard 120 and one or more output devices 122, such as a speaker 124 and a display 126. Other possible output devices (not shown) can include piezoelectric or other haptic output devices. Some devices can serve more than one input/output function. For example, the touchscreen 114 and the display 126 can be combined in a single input/output device. The input devices 112 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 104 or applications 106 can comprise speech-recognition software as part of a voice user interface that allows a user to operate the apparatus 100 via voice commands. Further, the apparatus 100 can comprise input devices and software that allows for user interaction via a user's spatial gestures, such as detecting and interpreting gestures to provide input to a gaming application.

A wireless modem 128 can be coupled to an antenna (not shown) and can support two-way communications between the processor 102 and external devices, as is well understood in the art. The modem 128 is shown generically and can include a cellular modem for communicating with a mobile communication network and/or other radio-based modems (e.g., Bluetooth or Wi-Fi). The wireless modem 128 is typically configured for communication with one or more cellular networks, such as a GSM network for data and voice communications within a single cellular network, a WCDMA (Wideband Code Division Multiple Access) network, an LTE (Long Term Evolution) network, a 4G LTE network, between cellular networks, or between the apparatus and a public switched telephone network (PSTN) etc.

The apparatus 100 can further include at least one input/output port 130, a satellite navigation system receiver 132, such as a Global Positioning System (GPS) receiver, an accelerometer 134, and/or a physical connector 136, which can be a USB port, IEEE 1394 (FireWire) port, and/or RS-232 port. The illustrated components 138 are not required or all-inclusive, as any components can deleted and other components can be added.

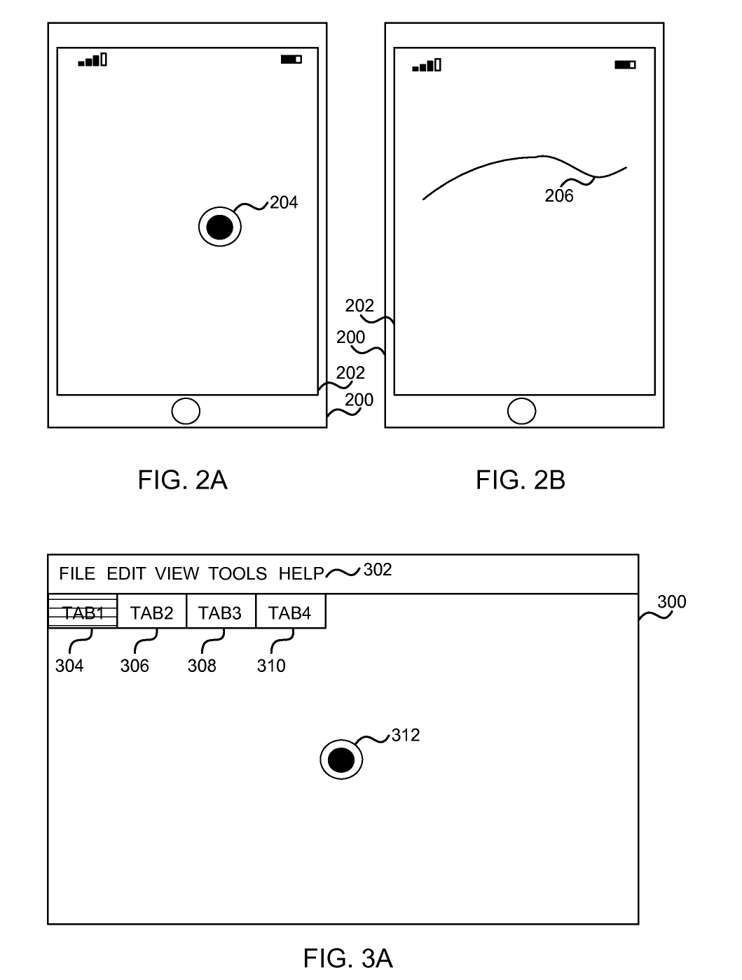

FIG. 2A illustrates an apparatus for selecting an interaction layer on a graphical user interface of an apparatus. The apparatus 200 may be, for example, a smart phone, a tablet computer, a laptop computer, a desktop computer, a Personal Digital Assistant (PDA) etc. The apparatus 200 may comprise a touch sensitive display that detects a user's touch on the display caused by, for example, a finger, multiple fingers, a stylus or pen or any other touching element. The apparatus 200 may also comprise a pressure level sensitive device configured to sense a pressure level of the touch applied on the touch sensitive display. The pressure level sensitive device may be a module integrated with the touch sensitive display or a separate module from the touch sensitive display. In another embodiment, the apparatus 200 may comprise a display device and a separate touch and pressure level sensitive user input device. With the touch and pressure level sensitive user input device the user is able to control content displayed on the display device of the apparatus 200. The embodiment of FIG. 2A is illustrated using a touch-sensitive display which is also able to detect the level of pressure applied on the touch sensitive display.

In FIG. 2A the apparatus 200 operates in a touch interaction layer. In the touch interaction layer, when the user's finger(s) (or a stylus) touches the touch-sensitive display, content on a graphical user interface 202 is, for example, selected, moved or zoomed. In order to enter a second interaction layer, a force touch interaction layer, the user firmly presses 204 the touch-sensitive display, as illustrated in FIG. 2B. There may be a predetermined pressure level that needs to be exceeded before the force touch interaction layer is entered. When it is detected that the pressure is released on the touch-sensitive display, the apparatus 200 switches to the force touch interaction layer. Detecting the release of the pressure may mean that the apparatus 200 detects that the pressure level on the touch-sensitive display becomes lower than the predetermined pressure level. Detecting the release of the pressure may also mean that the apparatus 200 detects that the user no longer touches the touch-sensitive display with this finger(s). Further, an indication may be provided to the user, the indication indicating the interaction layer mapped to the applied pressure level. The indication may comprise at least one of a visual indication, a tactile indication and a vocal indication. For example, the user may be provided with an indication on the touch-sensitive display that the applied pressure level has been mapped to the force touch interaction layer. Further, by providing an indication, the user is able to easily acknowledge when the mapping has been performed.

Once the force touch interaction layer has been entered, another interaction mode is in use. The interaction mode may be, for example, an inking or drawing mode. The user is able to draw, for example, a line 206 by moving his finger. When drawing the line, the user need not apply the greater pressure level used to enter the force touch interaction layer any more. To exit the force touch interaction layer, the user may again firmly press the touch-sensitive display with a pressure level exceeding the predetermined pressure level and then release the applied pressure level, and the apparatus 200 switches back the touch interaction layer.

The interaction layer switching as discussed above provides an easy and intuitive way to switch between interaction layers using a pressure level that exceeds the pressure level of a normal touch on the touch-sensitive display. This also enables a more efficient user-experience since the user does not have to select the interaction layer from any menus.

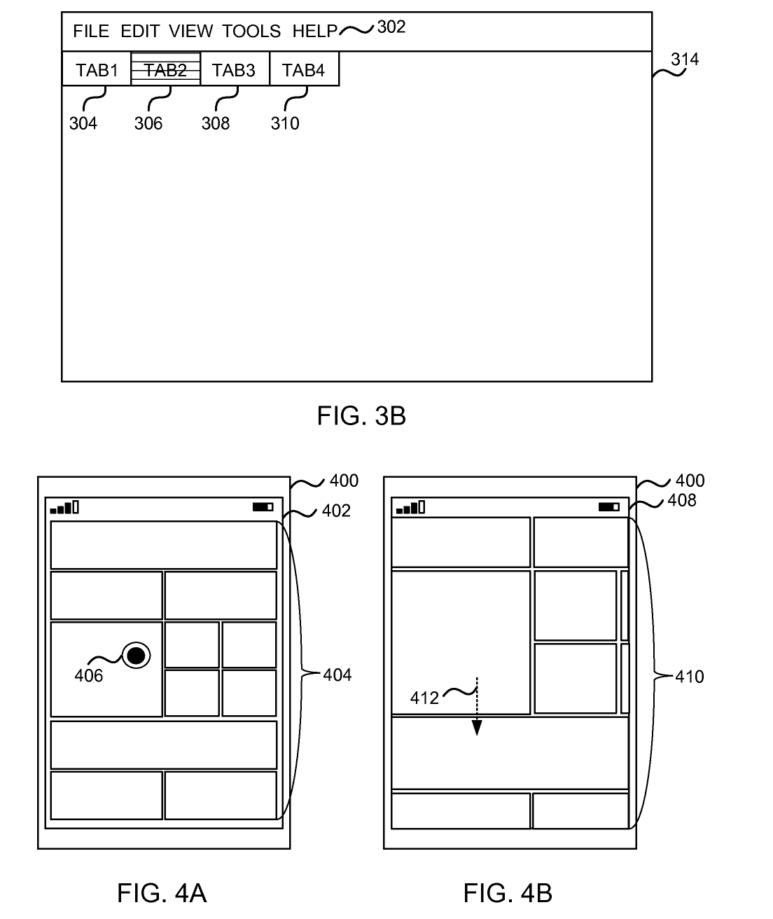

FIG. 3A illustrates a view 300 on a graphical user interface of an apparatus. The view presents, for example, a view of a browser application displayed by the apparatus. The apparatus 300 may be, for example, a smart phone, a tablet computer, a laptop computer, a desktop computer, a Personal Digital Assistant (PDA) etc. The apparatus may comprise a touch sensitive display that detects a user's touch on the display caused by, for example, a finger, multiple fingers, a stylus or pen or any other touching element. The apparatus may also comprise a pressure level sensitive device configured to sense a pressure level of the touch applied on the touch sensitive display. The pressure level sensitive device may be a module integrated with the touch sensitive display or a separate module from the touch sensitive display. In another embodiment, the apparatus may comprise a display device and a separate touch and pressure level sensitive user input device. With the touch and pressure level sensitive user input device the user is able to control content displayed on the display device of the apparatus. The embodiment of FIG. 3A is illustrated using a touch-sensitive display which is also able to detect the level of pressure applied on the touch sensitive display.

The top of the view 300 may comprise one or more browser-specific general menu items 302. Under the menu items 302, four tabs 304-310 are illustrated. Each tab may comprise a different currently open web page. The horizontal lines in TAB1 304 indicate that this tab is currently an active tab in the view 300. In this embodiment, the tabs 304-310 are regarded as interaction layers.

Normally, a user would select the desired tab by touching the tab with his finger(s) or a stylus. However, in this embodiment, an item 312 in the view 300 illustrates that the user firmly presses the touch sensitive display. The term “firmly” may mean that a predetermined pressure level is exceeded. A normal touch on the touch-sensitive display by the user to control normal operations on the view 300 does not yet exceed the predetermined pressure level but a higher pressure level is needed. The predetermined pressure level may be configured automatically or alternatively it may be user-configurable.

FIG. 3B illustrates a view 314 shown to the user after the user firmly pressed the touch sensitive display and then released the pressure applied on the touch sensitive display. The release of the pressure applied on the touch sensitive display is interpreted as a selection of the tab 306. The applied pressure level was mapped to the tab 306. Therefore, the tab 306 is now the active tab. “Releasing” the pressure applied on the touch-sensitive display may mean that the user removes his finger or fingers from the touch-sensitive display or that the pressure level applied on the touch-sensitive display decreases under the predetermined pressure level.

In one embodiment, if the user wanted to select tab 310, the user is able to make the selecting by applying a pressure level that maps to the tab 310 on the touch-sensitive display, When this pressure level is reached and the user releases the pressure applied on the touch sensitive display, this is interpreted as a selection of the tab 310. There may be a different pressure level mapped with each tab 304-310, and the selection of a desired tab is made by applying a correct amount of pressure on the touch-sensitive display.

FIGS. 3A and 3B illustrate a solution where the user is able switch between high level interaction layers (i.e. tabs) easily and intuitively. Further, the switching may be possible even if the pressure level is applied at any location point within the view 300.

FIG. 4A illustrates a view 402 on a display of an apparatus 400. The apparatus 400 is, for example, a mobile apparatus (a smart phone, a tablet computer etc.). The view 402 comprises a set of tiles 404, each tile enabling a different application to be launched. One or more of the tiles 404 may also display some application-specific information relating to the respective tile. In this embodiment, different interaction modes are regarded as interaction layers.

In a touch interaction mode, a user is able, for example, to scroll the view 402. An item 406 in the view 402 illustrates that the user firmly presses a touch sensitive display of the apparatus 400. The term “firmly” may mean that a predetermined pressure level is exceeded. A normal touch on the touch sensitive display by the user to control normal operations on the view 402 does not yet exceed the predetermined pressure level but a higher pressure level is needed. The predetermined pressure level may be configured automatically or alternatively it may be user-configurable.

FIG. 4B illustrates a zoom interaction mode in which a zoomed-in view 408 results in when the user firmly presses the touch-sensitive display, as illustrated in the view 402, and then releases the press, thus causing a change in the interaction mode on the touch sensitive display from touch interaction mode to the zoom interaction mode. Now that the user has activated the force touch interaction mode, the user need not continue using the “firm press” pressure level but may use a normal touch and pressure level. As illustrated in FIG. 4B by reference 412, the user touches the touch sensitive display and moves his finger down. This has the effect that tiles 410 on the view 408 are zoomed in. If the user then moves his finger up, the tiles 410 on the view 408 may be zoomed out.

FIGS. 4A and 4B illustrate a solution where the user is able to easily and intuitively switch between interaction layers or select an interaction layer by applying one or more predetermined pressure levels.

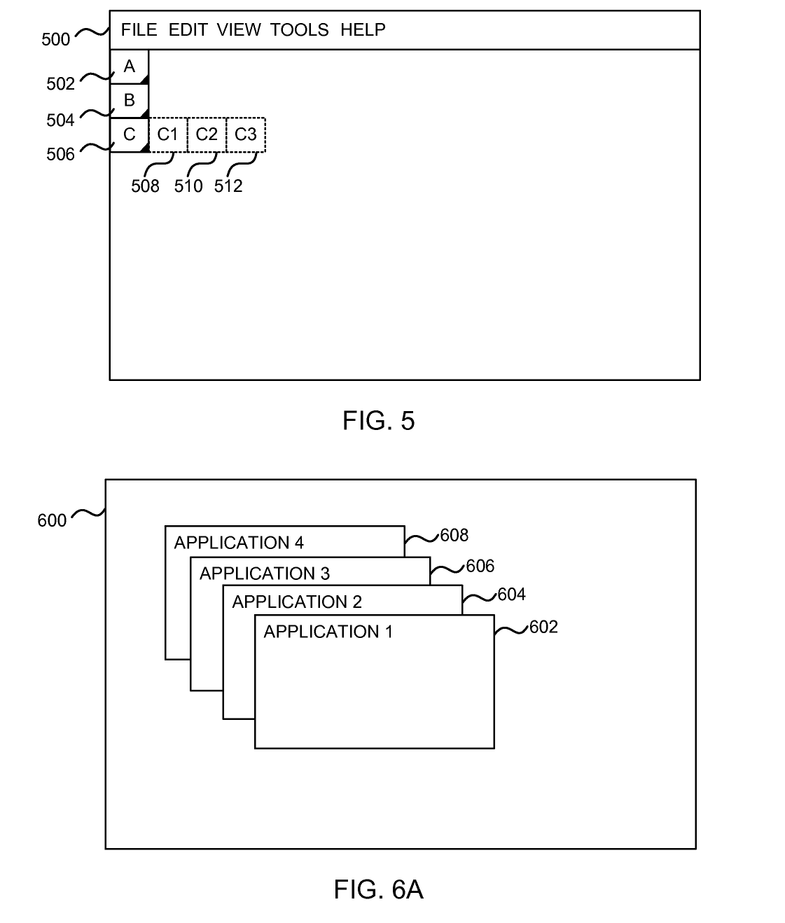

FIG. 5 illustrates a simplified application window view 500 provided by an apparatus. The apparatus may be, for example, a smart phone, a tablet computer, a laptop computer, a desktop computer, a Personal Digital Assistant (PDA) etc. The apparatus may comprise a touch sensitive display that detects a user's touch on the display caused by, for example, a finger, multiple fingers, a stylus or pen or any other touching element. The apparatus comprises also a pressure level sensitive device configured to sense a pressure level of the touch applied on the touch sensitive display. The pressure level sensitive device may be a module integrated with the touch sensitive display or a separate module from the touch sensitive display. In another embodiment, the apparatus may comprise a display device and a separate touch and pressure level sensitive user input device. With the touch and pressure level sensitive user input device the user is able to control content displayed on the display device of the apparatus. The embodiment of FIG. 5 is illustrated using a touch-sensitive display which is also able to detect the level of pressure applied on the touch sensitive display.

The application may be any application that provides various tools for a user, for example, a drawing application or an image processing application. The view 500 provides three tool items 502, 504, 506 that the user is able to select. The small black rectangle in each tool item 502, 504, 506 means that there are two or more sub-tool items relating to each tool item 502, 504, 506.

In a normal situation, the user would select one of the tools, for example, by touching the tool longer. In this case, the tool 506 would be selected. This may expand the tool item 506 to show all the related sub-tool items 508, 510, 512 from which the user is able to select the desired sub-tool via a touch. However, another possibility for the user to select a desired sub-tool item is to first touch the tool item 506 using a pressure level that exceeds a normally used touch pressure level.

In one embodiment, each sub-tool item 508, 510, 512 has been linked with a different predetermined pressure level. Let's assume that the user uses a moderate pressure level which associates to the sub-tool item 508. The view 500 may provide a visual indication that the current pressure level associates to the sub-tool item 508, for example, by shading the sub-tool item 508. If the user then releases his touch on the touch-sensitive display, this is detected by the apparatus and the apparatus interprets this as a selection of the sub-tool item 508. If the user applies more pressure on the touch sensitive display, new sub-tools items 510, 512 may associate to the increased pressure level. This means that the user may choose a desired sub-tool item 508, 510, 512 by applying a correct amount of pressure on the touch-sensitive display.

In another embodiment, the user may use a single pressure level exceeding a normally used touch pressure level to select any of the sub-tool items 508, 510, 512. When the user first starts to apply the pressure level exceeding a normally used touch pressure level, the sub-tool item 508 is first visually indicated, for example, by shading, as a preselected sub-tool item. When the user keeps the same pressure level for a predetermined period of time, the preselected sub-tool item changes to the next sub-tool item, and this may be indicated visually to the user. When the user then releases his touch on the touch-sensitive display, the sub-tool item that was the most recent preselected sub-tool item is considered as a selected sub-tool item.

FIG. 5 illustrates a solution where the user is able to easily and intuitively switch between tool and sub-tool items (interaction layers) or select a tool or sub-tool by applying one or more predetermined pressure levels on the touch sensitive display.

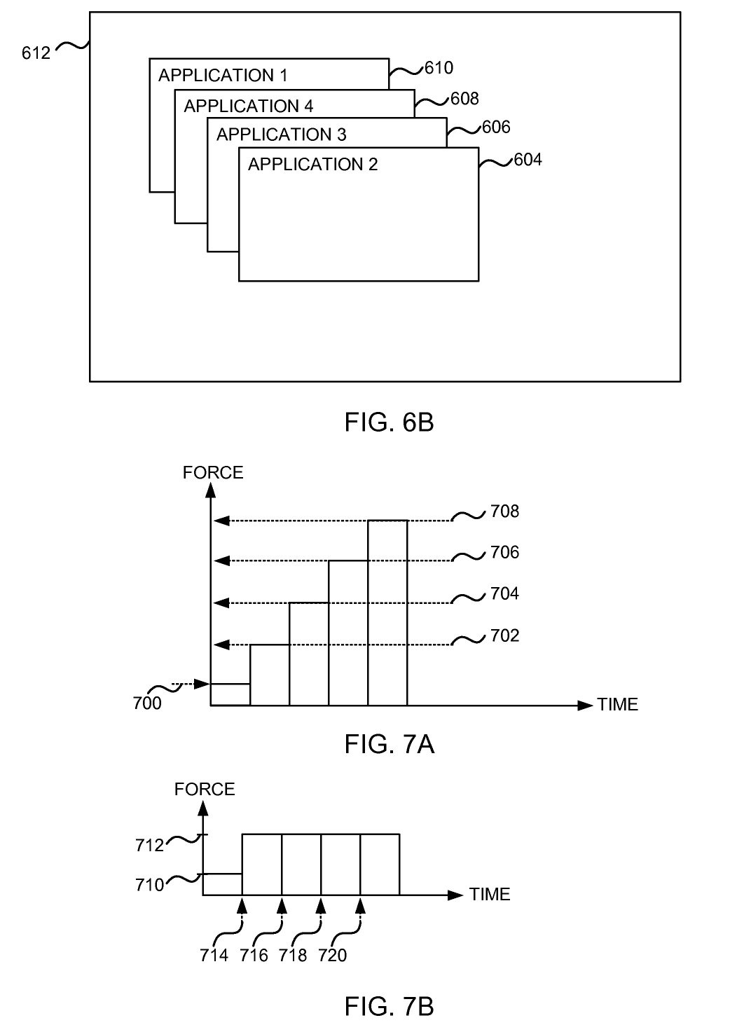

FIG. 6A illustrates a simplified application window selection view 600 provided by an apparatus. The apparatus may be, for example, a smart phone, a tablet computer, a laptop computer, a desktop computer, a Personal Digital Assistant (PDA) etc. The apparatus may comprise a touch sensitive display that detects a user's touch on the display caused by, for example, a finger, multiple fingers, a stylus or pen or any other touching element. The apparatus may also comprise also a pressure level sensitive device configured to sense a pressure level of the touch applied on the touch sensitive display. The pressure level sensitive device may be a module integrated with the touch sensitive display or a separate module from the touch sensitive display. In another embodiment, the apparatus may comprise a display device and a separate touch and pressure level sensitive user input device. With the touch and pressure level sensitive user input device the user is able to control content displayed on the display device of the apparatus. The embodiment of FIG. 6A is illustrated using a touch-sensitive display which is also able to detect the level of pressure applied on the touch sensitive display.

The view 600 shows all user applications in a cascaded manner currently executing in the apparatus. Before the user is given the cascaded application view, the user may have applied with his finger a pressure level that exceeds a normally used touch pressure level on the touch-sensitive display. This may be interpreted by the apparatus as a desire to change the currently active application displayed on the touch sensitive display. The application which was the active application before the user applied the pressure level that exceeds a normally used touch pressure level on the touch-sensitive display may be shown as the first application 602 in the cascaded application view.

When the user increases the pressure level applied on the touch-sensitive display, the order of the applications 602, 604, 606, 608 may change, and the application 604 may become as the first application in the cascaded view, as illustrated in FIG. 6B. If the user still increases the pressure level applied on the touch-sensitive display, the application 606 may become as the first application in the cascaded view. When the desired application is shown as the first application in the cascaded view, the user is able to select the application to be the currently active application by removing his finger from the touch-sensitive display thus releasing the pressure previously applied on the touch sensitive display.

FIGS. 6A and 6B a solution where the user is able to easily and intuitively switch between application windows by applying one or more predetermined pressure levels on the touch sensitive display.

In one embodiment of any of FIG. 2A, 2B, 3A, 3B, 4A, 4B, 5, 6A or 6B, an indication may be provided to a user, the indication indicating the interaction layer mapped to the pressure level. The indication may comprise at least one of a visual indication, a tactile indication and a vocal indication. When an indication is provided to the user, the user is easily able to notice which interaction layer is currently mapped to the applied pressure level. The visual indication may comprise a textual indication. For example, if the user is changing an operation mode (for example, from “a pointing mode” to “an drawing mode”), the textual indication may recite “drawing mode” when it is detected that the pressure level applied on the touch-sensitive display exceeds the predetermined pressure level and the applied pressure level has been mapped “drawing mode” (i.e. an interaction layer).

FIG. 7A illustrates an embodiment of pressure levels sensed by a touch and pressure level sensitive user input device of an apparatus. The touch and pressure level sensitive user input device may refer to a touch-sensitive display able to detect touch and multiple pressure levels. The pressure level sensitive user input device may also refer to an external user input device connected to the apparatus or to a user input device integrated to the apparatus, for example, a touch pad that is able to detect different pressure levels. For simplicity, FIG. 7A is illustrated using the touch sensitive display able to detect multiple pressure levels as an example.

In FIG. 7A illustrates an embodiment when there are multiple interaction layers and there is a predetermined pressure level associated with each interaction layer. The term “interaction layer” may refer to any application or item on the graphical user interface or to a mode, which can be selected by the user.

A pressure level 700 illustrates a normal touch pressure level on the touch-sensitive display. In addition to the normal pressure level 700, there are four other pressure levels 702, 704, 706, 708 illustrated in FIG. 7A associated to four different interaction layers. By altering the pressure level applied on the touch-sensitive display, a user is able to select any of the interaction layers associated to the four pressure levels. By associating the pressure levels with different interaction layers, it is possible to provide an intuitive and powerful way of activating the desired interaction layer.

FIG. 7B illustrates an embodiment of pressure levels sensed by a pressure level sensitive user input device of an apparatus. The pressure level sensitive user input device may refer to a touch sensitive display able to detect multiple pressure levels from a user's touch. The pressure level sensitive user input device may also refer to an external user input device connected to the apparatus or to a user input device integrated to the apparatus, for example, a touch pad. For simplicity, FIG. 7B is illustrated using the touch sensitive display able to detect multiple pressure levels as an example.

FIG. 7B illustrates an embodiment when there are multiple interaction layers and only one pressure level 712 is used to control the selection of a desired interaction layer. A pressure level 710 illustrates a normal touch on the touch sensitive display. In addition to the normal pressure level 700, the pressure level 712 is used to control the selection of the graphical user interface interaction layers. When a user starts to apply the pressure level 712 (or a pressure level exceeding the pressure level 712) on the touch sensitive display at a time point 714, a first interaction layer is mapped to the pressure level 712. During the time period between time points 714 and 716, the first interaction layer remains as the layer mapped to the pressure level 712. However, when the user maintains the pressure level 712, at a time point 716 a second interaction layer is mapped to the pressure level 712. Similarly, when the user still maintains the pressure level 712, at a time point 718 a third interaction layer is mapped to the pressure level 712. Similarly, when the user still maintains the pressure level 712, at a time point 720 a fourth interaction layer is mapped to the pressure level 712. The time values between the time points may be user configurable or they may be configured automatically.

As discussed above, time may be used as an additional parameter for determining the interaction layer mapped to the pressure level 712. The time period between the time points (for example, the time period between time points 714 and 716) may be user configurable. Alternatively, it may be configured automatically by the apparatus to be a default time period. When time is used as additional parameter in addition to a single predetermined pressure level, the user does not have to vary the pressure level applied on the touch-sensitive display. Instead, it is sufficient that the applied pressure level exceeds the predetermined pressure level, and a timer is used to initiate the switch between the interaction layers.

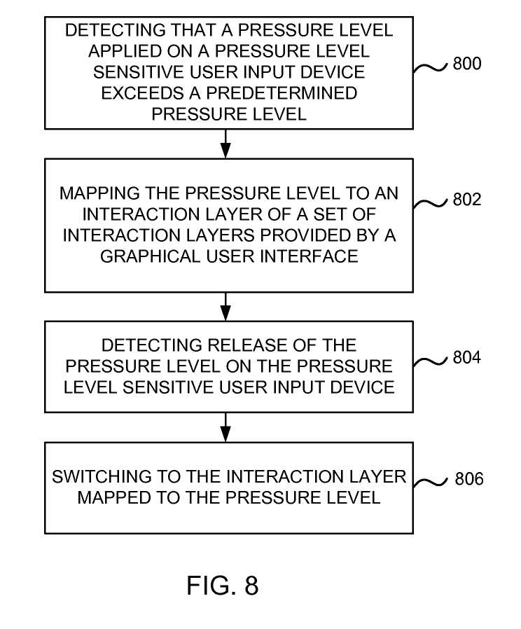

FIG. 8 discloses a flow diagram illustrating an embodiment of a method for selecting an interaction layer on a graphical user interface.

In 800 a pressure level applied on a pressure level sensitive user input device is detected. The pressure level sensitive user input device may refer, for example, to a touch sensitive display that is able to detect a pressure level applied on the display or to a touch pad used on control an apparatus.

In 802 the pressure level is mapped to an interaction layer of a set of interaction layers provided by the graphical user interface. The term “interaction layer” may refer to any application, application item or other item on the graphical user interface or to an interaction mode, which can be selected by the user.

In 804 release of the pressure on the pressure level sensitive user input device is detected.

In 806 the interaction layer mapped to the pressure level is switched to in response to detecting the release of the pressure level on the pressure level sensitive user input device.

At least some of the embodiments provide one more of the following effects. A solution is provided that enables more efficient use of a user interface and leads also to improved user-experience. The user is able to easily and intuitively switch between interaction layers or select an interaction layer by applying one or more predetermined pressure levels.

According to an aspect, there is provided an apparatus comprising at least one processing unit, at least one memory, a pressure level sensitive user input device, and a graphical user interface. The at least one memory stores program instructions that, when executed by the at least one processing unit, cause the apparatus to detect that a pressure level applied on the pressure level sensitive user input device exceeds a predetermined pressure level, map the pressure level to an interaction layer of a set of interaction layers provided by the graphical user interface, provide an indication to a user, the indication indicating the interaction layer mapped to the pressure level, wherein the indication comprises at least one of a visual indication, a tactile indication and a vocal indication, detect release of the pressure on the pressure level sensitive user input device, and switch to the interaction layer mapped to the pressure level in response to detecting the release of the pressure level on the pressure level sensitive user input device.

According to another aspect, there is provided an apparatus comprising at least one processing unit, at least one processing unit, at least one memory, a pressure level sensitive user input device, and a graphical user interface. The at least one memory stores program instructions that, when executed by the at least one processing unit, cause the apparatus to detect that a pressure level applied on the pressure level sensitive user input device exceeds a predetermined pressure level, map the pressure level to an interaction layer of a set of interaction layers provided by the graphical user interface, detect release of the pressure on the pressure level sensitive user input device, and switch to the interaction layer mapped to the pressure level in response to detecting the release of the pressure level on the pressure level sensitive user input device.

In one embodiment, each interaction layer is associated with a different pressure level.

In one embodiment, alternatively or in addition, the at least one memory stores program instructions that, when executed by the at least one processing unit, cause the apparatus to detect an increase in the pressure level applied on the pressure level sensitive user input device, and map the increased pressure level to another interaction layer of the set of interaction layers provided by the graphical user interface.

In one embodiment, alternatively or in addition, a single pressure level is associated with all interaction layers in the set of interaction layers.

In one embodiment, alternatively or in addition, the at least one memory stores program instructions that, when executed by the at least one processing unit, cause the apparatus to start a timer after mapping the pressure level to the interaction layer of the set of interaction layers, detect expiration of the timer, and map the pressure level to a subsequent interaction layer of the set of interaction layers in response to detecting the expiration of the timer,

In one embodiment, alternatively or in addition, the at least one memory stores program instructions that, when executed by the at least one processing unit, cause the apparatus to provide an indication to a user, the indication indicating the interaction layer mapped to the pressure level, wherein the indication comprises at least one of a visual indication, a tactile indication and a vocal indication.

In one embodiment, alternatively or in addition, the set of interaction layers comprise tabs within a single application.

In one embodiment, alternatively or in addition, the set of interaction layers comprise active applications accessible via the graphical user interface.

In one embodiment, alternatively or in addition, the set of interaction layers comprise sub-items of a graphical user interface item.

In one embodiment, alternatively or in addition, the set of interaction layers are application specific.

In one embodiment, alternatively or in addition, the predetermined pressure level is user-configurable.

In one embodiment, alternatively or in addition, the predetermined pressure level is configured automatically.

According to an aspect, there is provided a method comprising detecting that a pressure level applied on the pressure level sensitive user input device exceeds a predetermined pressure level, mapping the pressure level to an interaction layer of a set of interaction layers provided by the graphical user interface, detecting release of the pressure on the pressure level sensitive user input device, and switching to the interaction layer mapped to the pressure level in response to detecting the release of the pressure level on the pressure level sensitive user input device.

In one embodiment, each interaction layer is associated with a different pressure level.

In one embodiment, alternatively or in addition, the method comprises detecting an increase in the pressure level applied on the pressure level sensitive user input device, and mapping the increased pressure level to another interaction layer of the set of interaction layers provided by the graphical user interface.

In one embodiment, alternatively or in addition, a single pressure level is associated with all interaction layers in the set of interaction layers.

In one embodiment, alternatively or in addition, the method comprises starting a timer after mapping the pressure level to the interaction layer of the set of interaction layers, detecting expiration of the timer, and mapping the pressure level to a subsequent interaction layer of the set of interaction layers in response to detecting the expiration of the timer,

In one embodiment, alternatively or in addition, the method comprises providing an indication to a user, the indication indicating the interaction layer mapped to the pressure level, wherein the indication comprises at least one of a visual indication, a tactile indication and a vocal indication.

In one embodiment, alternatively or in addition, the set of interaction layers comprise tabs within a single application.

In one embodiment, alternatively or in addition, the set of interaction layers comprise active applications accessible via the graphical user interface.

In one embodiment, alternatively or in addition, the set of interaction layers comprise sub-items of a graphical user interface item.

In one embodiment, alternatively or in addition, the set of interaction layers are application specific.

In one embodiment, alternatively or in addition, the predetermined pressure level is user-configurable.

In one embodiment, alternatively or in addition, the predetermined pressure level is configured automatically.

According to another aspect, there is provided a computer program comprising program code, which when executed by at least one processor, causes an apparatus to perform detecting that a pressure level applied on the pressure level sensitive user input device exceeds a predetermined pressure level, mapping the pressure level to an interaction layer of a set of interaction layers provided by the graphical user interface, detecting release of the pressure on the pressure level sensitive user input device, and switching to the interaction layer mapped to the pressure level in response to detecting the release of the pressure level on the pressure level sensitive user input device.

In one embodiment, the computer program is embodied on a computer-readable medium.

According to another aspect, there is provided an apparatus comprising a pressure level sensitive user input device and a graphical user interface. The apparatus further comprises means for detecting that a pressure level applied on the pressure level sensitive user input device exceeds a predetermined pressure level, means for mapping the pressure level to an interaction layer of a set of interaction layers provided by the graphical user interface, means for detecting release of the pressure on the pressure level sensitive user input device, and means for switching to the interaction layer mapped to the pressure level in response to detecting the release of the pressure level on the pressure level sensitive user input device.

According to another aspect, there is provided an apparatus comprising a pressure level sensitive user input device and a graphical user interface. The apparatus further comprises means for detecting that a pressure level applied on the pressure level sensitive user input device exceeds a predetermined pressure level, means for mapping the pressure level to an interaction layer of a set of interaction layers provided by the graphical user interface, means for providing an indication to a user, the indication indicating the interaction layer mapped to the pressure level, wherein the indication comprises at least one of a visual indication, a tactile indication and a vocal indication, means for detecting release of the pressure on the pressure level sensitive user input device, and means for switching to the interaction layer mapped to the pressure level in response to detecting the release of the pressure level on the pressure level sensitive user input device.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

The functions described herein performed by a controller may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

Although the subject matter may have been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages.

Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification. In particular, the individual features, elements, or parts described in the context of one example, may be connected in any combination to any other example also.

1. An apparatus, comprising:
at least one processing unit;
at least one memory;
a pressure level sensitive user input device;
a graphical user interface;
wherein the at least one memory stores program instructions that, when executed by the at least one processing unit, cause the apparatus to:
detect that a pressure level applied on the pressure level sensitive user input device exceeds a predetermined pressure level;
map the pressure level to an interaction layer of a set of interaction layers provided by the graphical user interface;
detect release of the pressure on the pressure level sensitive user input device; and
switch to the interaction layer mapped to the pressure level in response to detecting the release of the pressure level on the pressure level sensitive user input device.

2. An apparatus according to claim 1, wherein each interaction layer is associated with a different pressure level.

3. An apparatus according to claim 2, wherein the at least one memory stores program instructions that, when executed by the at least one processing unit, cause the apparatus to:
detect an increase in the pressure level applied on the pressure level sensitive user input device; and
map the increased pressure level to another interaction layer of the set of interaction layers provided by the graphical user interface.

4. An apparatus according to claim 1, where a single pressure level is associated with all interaction layers in the set of interaction layers.

5. An apparatus according to claim 4, wherein the at least one memory stores program instructions that, when executed by the at least one processing unit, cause the apparatus to:
start a timer after mapping the pressure level to the interaction layer of the set of interaction layers;
detect expiration of the timer; and
map the pressure level to a subsequent interaction layer of the set of interaction layers in response to detecting the expiration of the timer.

6. An apparatus according to claim 1, wherein the at least one memory stores program instructions that, when executed by the at least one processing unit, cause the apparatus to:
provide an indication to a user, the indication indicating the interaction layer mapped to the pressure level, wherein the indication comprises at least one of a visual indication, a tactile indication and a vocal indication.

7. An apparatus according to claim 1, wherein the set of interaction layers comprise tabs within a single application.

8. An apparatus according to claim 1, wherein the set of interaction layers comprise active applications accessible via the graphical user interface.

9. An apparatus according to claim 1, wherein the set of interaction layers comprise sub-items of a graphical user interface item.

10. An apparatus according to claim 1, wherein the set of interaction layers are application specific.

11. An apparatus according to claim 1, wherein the predetermined pressure level is user-configurable.

12. An apparatus according to claim 1, wherein the predetermined pressure level is configured automatically.

13. A method, comprising:
detecting that a pressure level applied on the pressure level sensitive user input device exceeds a predetermined pressure level;
mapping the pressure level to an interaction layer of a set of interaction layers provided by the graphical user interface;
detecting release of the pressure on the pressure level sensitive user input device; and
switching to the interaction layer mapped to the pressure level in response to detecting the release of the pressure level on the pressure level sensitive user input device.

14. A method according to claim 13, wherein each interaction layer is associated with a different pressure level.

15. A method according to claim 14, further comprising:
detecting an increase in the pressure level applied on the pressure level sensitive user input device; and
mapping the increased pressure level to another interaction layer of the set of interaction layers provided by the graphical user interface.

16. A method according to claim 13, where a single pressure level is associated with all interaction layers in the set of interaction layers.

17. A method according to claim 16, further comprising:
starting a timer after mapping the pressure level to the interaction layer of the set of interaction layers;
detecting expiration of the timer; and
mapping the pressure level to a subsequent interaction layer of the set of interaction layers in response to detecting the expiration of the timer.

18. A method according to claim 13, further comprising:
providing an indication to a user, the indication indicating the interaction layer mapped to the pressure level, wherein the indication comprises at least one of a visual indication, a tactile indication and a vocal indication.

19. A method to claim 13, wherein the predetermined pressure level is configured automatically or is user-configurable.

20. An apparatus, comprising:
at least one processing unit;
at least one memory;
a pressure level sensitive user input device;
a graphical user interface;
wherein the at least one memory stores program instructions that, when executed by the at least one processing unit, cause the apparatus to:
detect that a pressure level applied on the pressure level sensitive user input device exceeds a predetermined pressure level;
map the pressure level to an interaction layer of a set of interaction layers provided by the graphical user interface;
provide an indication to a user, the indication indicating the interaction layer mapped to the pressure level, wherein the indication comprises at least one of a visual indication, a tactile indication and a vocal indication;
detect release of the pressure on the pressure level sensitive user input device; and
switch to the interaction layer mapped to the pressure level in response to detecting the release of the pressure level on the pressure level sensitive user input device.
